(19) United States
(12) Patent Application Publication
(10) Pub. No.: US 2009/0094872 A1
(43) Pub. Date: Apr. 16, 2009

(54) LASER WRISTBAND TAGS

(75) Inventors: Sherif Ali, Los Angeles, CA (US); Kim Canchola, Lancaster, CA (US); Russell Smith, Newhall, CA (US)

Correspondence Address: KELLY LOWRY & KELLEY, LLP, 6320 CANOGA AVENUE, SUITE 1650, WOODLAND HILLS, CA, 91367, US

(73) Assignee: PRECISION DYNAMICS CORPORATION, San Fernando, CA (US)

(21) Appl. No.: 12/246,636

(22) Filed: Oct. 7, 2008

Related U.S. Application Data
(60) Provisional application No. 60/979,209, filed on Oct. 11, 2007.

(51) Int. Cl. G09F 3/00

(52) U.S. Cl. 40/633

(57) ABSTRACT

The wristband system includes a tag having an identification area for receiving information associated with an object to be identified. A dual attachment mechanism is associated with the tag and generally includes a slit in the tag and an adhesive disposed on at least a portion of the tag. The wristband system further includes an elongated flexible strap having a fastener for retaining the strap in a closed loop configuration around the object to be identified. In turn, the tag is configured to fixedly attach to the strap by threaded engagement of the slit or retention by the adhesive.

### BACKGROUND OF THE INVENTION

The present invention relates to laser wristband tags. More particularly, the invention relates to laser wristband tags capable of receiving print-on-demand RFID, bar code, or human readable information and securable to a wristband via an adhesive closure mechanism or via a pair of slits. The tags may be applied to the wristband before or after the wristband is applied to the object to be identified.

Identification bands such as a wristband, bracelet, or other closed-loop identification device are generally known in the art. These bands carry some form of information concerning an identified object. Wristbands typically comprise an elongated flexible strap formed from plastic or the like. For positive patient identification, in medical applications, the wristband is wrapped about the wrist of an authorized wearer, such as a patient. The wristband commonly includes interfitting or interengageable securement members at opposite ends of the wristband thereof. These interengageable securement members retain the wristband in a closed loop around the object to be identified. Thereafter, the interconnected wristband retained around the patient's wrist is used to identify the patient.

Such wristbands known in the art are also provided with a plurality of labels or tags. The combination wristband, labels, and tags are commonly printed within the same sheet stock. Labels are securable to the band or other surface via an adhesive and the tags are adapted for slide-fit mounting into a pocket or a strap portion of the wristband. A common use for such an identification wristband, label, and tag is the aforesaid medical facility setting. For example, the wristband is used for personal identification and/or access control at secured facilities. Other applications include military or industrial installations, prisons, and the like.

In recent years, improved identification systems include identification bands and tags designed to incorporate wearer-related data in machine readable form. Machine readable form is preferred over traditional human readable data because human readable data is typically limited in space and limited to the clarity of handwritten or printed alphanumeric characters. Machine readable data may be stored in a variety of technologies, including bar code or RFID. Accordingly, data is conveniently accessed by scanning the bar code with a conventional reader or receiving radio signals emitted by an RFID chip. Machine readable data is also preferable over human readable data as electronic circuits are capable of storing more data on the wristband. Machine readable data technologies permit substantial increases in the volume of the wearer-related data carried by the identification band. Comparable conventional prior art bands bearing information only in human readable form are limited to the applicable printable space on the band.

Current identification bands bearing or carrying wearer-related information in human readable or machine readable form are typically constructed from relatively stiff plastic-based materials. These wristbands are designed to provide sturdy and durable substrates suitable for permanent printing of information thereon. Plastic-based wristbands also effectively support and protect RFID circuitry and other electronic devices disposed therein. An outer clear plastic layer or laminate may also protect the bar codes. Unfortunately, such plastic-based wristbands can exhibit relatively abrasive or sharp edges. Hence, the wristbands tend to be uncomfortable to wear over extended durations. But, covering printed information prolongs the integrity, lifespan and ultimately the readability of the information on the wristband.

Some wristband designs known in the art also include an adhesive closure mechanism integrated with the laminated feature protecting the printed information. Such an adhesive closure mechanism allows the end user to handle a single wristband component. That is, end users need not worry about additional attachments or other securement devices. But, such wristbands have limited space for bar codes. In turn, these bar codes are often difficult to scan. Any significant curvature of a printed and laminated wristband wrapped around an object to be identified may cause bar code puckering. Puckering tends to disrupt the material continuity of the wristband such that moisture may enter the interior of the wristband thereby causing the bar code or other printed information to bleed or smudge. A smudged bar code may become un-scanable over time. Additionally, limiting wristband designs to an adhesive closure limits the number of materials that can be utilized. For example, only materials that react to or adhere to a pressure sensitive adhesive are usable with such a wristband. In turn, band durability and longevity is compromised by appropriate material selection. In some cases, these wristbands may only last up to three days.

Accordingly, there is a need for laser wristband tags that have both an adhesive closure and slide-fit engagement mechanism integrated therein. Such wristband tags should also include an identification area for clearly receiving and retaining a bar code or other printable information thereon. The laser wristband tag should accordingly be incorporated into a multipart form with a corresponding wristband and, optionally, other identification information, tags, or labels. The present invention fulfills these needs and provides further related advantages.

### SUMMARY OF THE INVENTION

The laser wristband tag system of the present invention includes a tag having an identification area for receiving information associated with an object to be identified. The tag includes a dual attachment mechanism that includes a slit in the tag and an adhesive disposed on at least a portion of the tag. The dual attachment mechanism is used in association with an elongated flexible strap having a fastener for retaining the strap in a closed loop configuration around the object to be identified. Accordingly, the tag is configured to fixedly attach to the strap by threaded engagement of the slit or by retention of the adhesive. In one embodiment, the slit comprises a plurality of slits, each of which are configured for threaded reception by the strap. The identification area of the tag remains substantially unobstructed after threaded engagement of the tag to the strap. Alternatively, the adhesive may adhere directly to the strap or adhere to the tag itself for looped attachment around the strap, after the strap is secured around the object to be identified. Furthermore, the adhesive may be disposed between a selectively removable protective cover and a tab integral to the tag.

In another embodiment of the present invention, the tag, the strap and an associated label may comprise at least a portion of a printable multi-part form. Here, score lines detachably define the tag, the label or the strap in the multi-part form. The label and the strap may also include an identification area for receiving printed information associated with the object to be identified. Accordingly, the tag, the strap and the label may receive human readable alphanumeric characters and/or machine readable information in each respective identification area. In one embodiment, the machine readable information comprises a bar code. In an alternative embodiment, the tag comprises an RFID circuit capable of storing information regarding the object to be identified. Like the bar code, the RFID circuit is similarly machine readable.

In another aspect of the present invention, the fastener on the strap comprises an adhesive retention mechanism and a mechanical retention mechanism. More specifically, the adhesive retention mechanism comprises an adhesive disposed on at least a portion of the strap. Further, the mechanical retention mechanism may comprise a complementary pair of connectors. In this regard, the strap includes a plurality of snap-slits configured for selective reception of the connectors. The strap may include an alignment slot to prevent twisting and an elongated flexible extender for lengthening the size of the strap.

Alternatively, the strap may include one or more closure mechanism receiving apertures presenting a substantially contiguous planar surface. The closure mechanism receiving apertures preferably include an arcuate cut and a post-slit approximate thereto. The post-slit should be oriented generally longitudinally along the strap and generally perpendicular to the arcuate cut. The post-slit may comprise a V-shaped cut generally centered on a radius of the arcuate cut or an X-shaped cut likewise centered on a radius of the arcuate cut. The arcuate cut is preferably positioned at an end of each of the X-shaped cuts.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top view of a multi-part form having a plurality of tags and labels integrated therein;

FIG. 2 is an alternative embodiment of the multi-part form of FIG. 1, further including a wristband for use with the laser wristband tags of the present invention;

FIG. 3 is a top view of the wristband, illustrating exposing an adhesive at a front end thereof;

FIG. 4 is a top view of the laser wristband tag, illustrating exposing an adhesive underlying a tab;

FIG. 5 is a cross-sectional view of the laser wristband tag in FIG. 4, taken about the line 5-5;

FIG. 6 is a top view illustrating attachment of the laser wristband tag to the wristband via a pair of slits;

FIG. 7 is another top view of the laser wristband tag attached to the wristband by the adhesive;

FIG. 8 is a perspective view of the tag of the present invention, illustrating looped attachment to the wristband;

FIG. 9 is a top view of the wristband incorporating a closure mechanism receiving aperture;

FIG. 10 is a top view of the wristband incorporating an alternate embodiment of the closure mechanism receiving aperture;

FIG. 11 is a top view of the wristband incorporating another alternate embodiment of the closure mechanism receiving aperture;

FIG. 12 is a top view of the wristband incorporating yet another alternate embodiment of the closure mechanism receiving aperture;

FIG. 13 is an enlarged view of the closure mechanism receiving aperture of FIG. 9;

FIG. 14 is an enlarged view of the alternate closure mechanism receiving aperture of FIG. 10;

FIG. 15 is an enlarged view of the alternate closure mechanism receiving aperture of FIG. 11; and

FIG. 16 is an enlarged view of the alternate closure mechanism receiving aperture of FIG. 12.

### DETAILED DESCRIPTION OF THE PREFERRED EMBODIMENTS

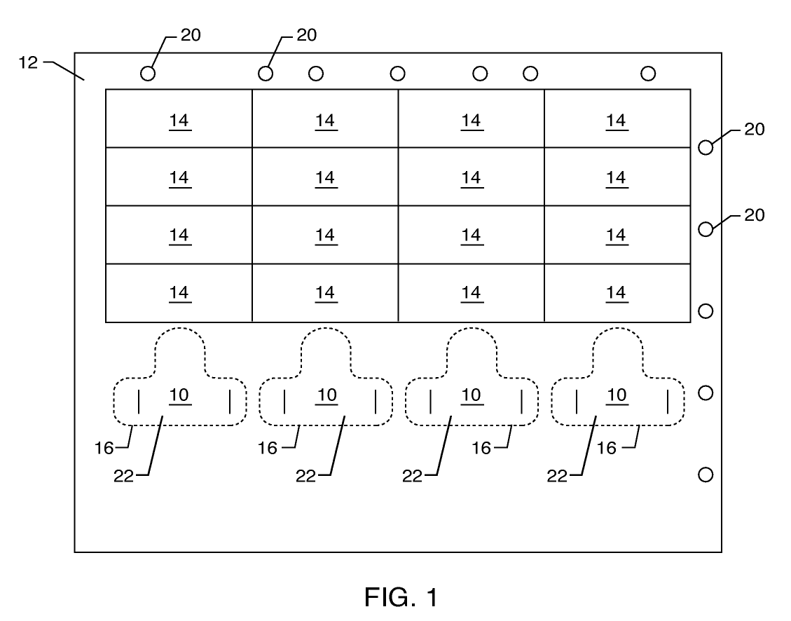

As shown in the drawings for purposes of illustration, a laser wristband tag is referred generally by the reference number 10. FIG. 1 illustrates the laser wristband tag 10 formed as part of a multi-part form 12, which also includes a plurality of labels 14. The laser wristband tags 10 are separable from the multi-part form 12 via a plurality of score lines 16 disposed around the exterior of each laser wristband tag 10. The score lines 16 permit detachment of each laser wristband tag 10 from the multi-part form 12. The laser wristband tags 10 may be formed integral to the multi-part form 12 or be constructed from layers of the multi-part form 12. For example, when the laser wristband tags 10 are ready for application, a user removes each laser wristband tag 10 along the score lines 16 to separate each laser wristband tag 10 from the multi-part form 12. In this embodiment, the laser wristband tags 10 comprise every layer of the multi-part form 12. That is, after removal, the multi-part form 12 has a hole where each laser wristband tag 10 was removed. Alternatively, the user may peel each laser wristband tag 10 away from a substrate that forms the base of the multi-part form 12. This base (not shown) of the multi-part form 12 effectively carries the laser wristband tags 10. The base material remains, unlike the previous embodiment, after the laser wristband tags 10 are removed from the multi-part form 12.

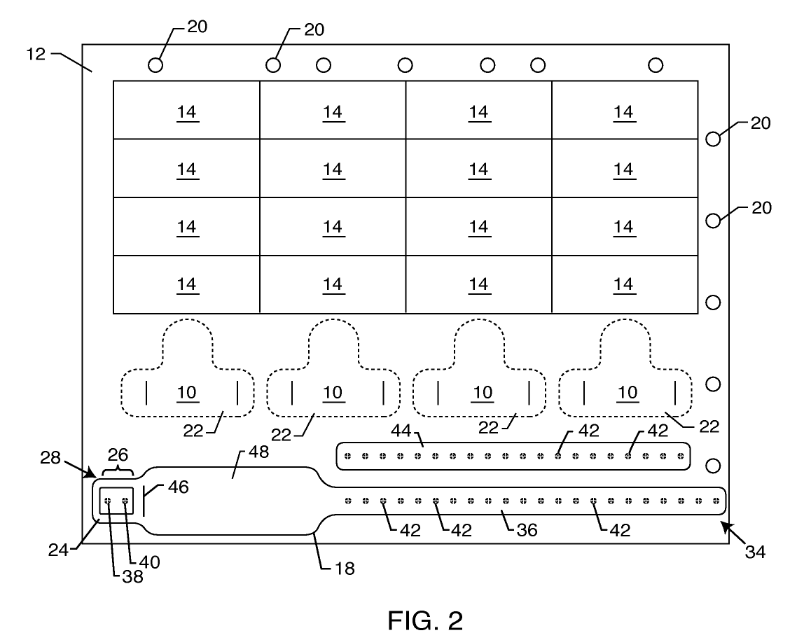

Likewise, the labels 14 and a wristband 18 (FIG. 2) are also formed from layers that comprise the multi-part form 12. In one embodiment, the labels 14 and the wristband 18 may comprise every layer of the multi-part form 12 such that removal therefrom leaves a hole in the multi-part form 12. Alternatively, the labels 14 and the wristband 18 may be formed from a peelable layer carried by the aforementioned base (not shown). In another alternative embodiment of the present invention, the laser wristband tags 10, the labels 14 and the wristband 18 may comprise different layers of the multi-part form 12. For example, the labels 14 may peel away from the base of the multi-part form 12, while the laser wristband tags, integrated into the same multi-part form 12, may comprise every layer of the multi-part form 12 and leave a hole therein upon removal. Moreover, the multi-part form 12 may include a comfort liner (not shown) to enhance wearer comfort when associated with the wristband 18. Accordingly, the laser wristband tags 10, the labels 14, and the wristband 18 could all be integrated together into a single multi-part form 12 as illustrated in FIG. 2.

The multi-part form 12 is preferably capable of feeding through any one of a number of different standard printers known in the art. Such printers may include laser printers, inkjet printers, or dot matrix printers. It is preferred in the present invention that the multi-part form 12 be used in conjunction with a laser printer. Dot matrix printers may require a plurality of feed apertures 20 disposed around the periphery of the multi-part form 12 as illustrated in FIGS. 1 and 2. The multi-part form 12 feeds into the dot matrix printer whereby roller pins protrude through the feed apertures 20 for engagement thereto. Locating the feed apertures 20 around the periphery of the multi-part form 12 enables the multi-part form 12 to feed through the dot matrix printer either horizontally or vertically. Moreover, the laser wristband tags 10 preferably include an identification area 22 capable of receiving printed indicia thereon. For example, feeding the multi-part form 12 through a dot matrix printer via the feed apertures 20 allows the printer head (not shown) to print a bar code or other identifying information directly to the identification area 22 of the laser wristband tags 10. In general, the top surface comprising the multi-part form 12 should comprise a material capable of receiving printed information from any of the aforementioned printers. This enables the laser wristband tags 10, the labels 14 and the wristband 18 to receive printed information thereon. Accordingly, the laser wristband tags 10, the labels 14 and the wristband 18 should be capable of receiving standard black and white printed material (e.g. a bar code) or a high quality multi-color image (e.g. a photograph of a patient). Of course, the level of detail printed to the laser wristband tags 10, the labels 14 or the wristband 18 depends on the quality of the printer and the corresponding material of the multi-part form 12 receiving the information.

In FIG. 2, the wristband 18 provides a low-cost identification band capable of receiving print-on-demand RFID, bar code, or human readable information. This enables the wristband 18 to have a wide range of applications for identifying objects. For example, the wristband 18 may be designed for use in hospitals. In one embodiment, the wristband 18 is used for positive patient identification, medical administration, patient care identification, and medical alerts, including allergies, fall risks, and do not resuscitate (DNR). The wristband 18 can also be used in maternity wards to coordinate the association of mothers and infants. For example, corresponding wristbands 18 are applied to a mother and infant at birth. Each wristband 18 contains information identifying both the mother and the infant. The laser wristband tags 10 can be added to the mother or infant wristband 18 before or after application of the wristband 18 to the patient, as more fully described herein.

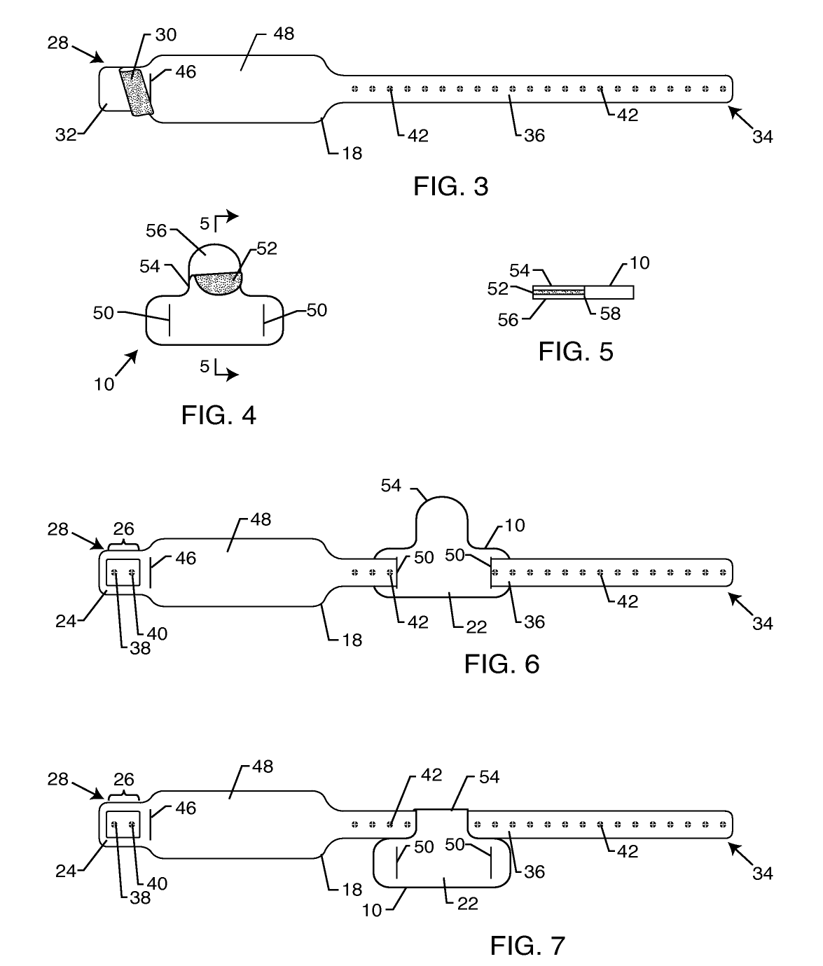

The wristband 18 illustrated in FIG. 2 includes a dual closure mechanism. The dual closure mechanism comprises an adhesive closure mechanism 24 and a clasp closure mechanism 26. Both mechanisms 24, 26 are located at a front end 28 of the wristband 18. More specifically, the adhesive closure mechanism 24 includes an adhesive layer 30, as shown in FIG. 3. A protective cover 32 on the front end 28 of the wristband 18 peels back to expose the adhesive layer 30. The protective cover 32 protects at least part of the adhesive layer 30 before application of the wristband 18 to an object to be identified. The adhesive layer 30 may comprise any adhesive known in the art capable of retaining the wristband 18 in a closed loop configuration. Of course, the adhesive layer 30 may vary in size, shape or composition depending on the desired use and/or type of material comprising the wristband 18. To use the adhesive closure mechanism 24, the wristband 18 is first detached from the multi-part form 12. Then, the protective cover 32 is removed in the manner illustrated in FIG. 3, to expose the adhesive layer 30. The front end 28 is then adhesively secured to a rear end 34 of a strap 36. In one embodiment, the protective cover 32 may be formed as part of the aforementioned base layer of the multi-part form 12. In this embodiment, a set of score lines (not shown) allows the protective cover 32 to tear away from the main body of the wristband 18 upon removal from the multi-part form 12. In another alternative embodiment, the wristband 18 is completely removed from the multi-part form 12 and the user subsequently detaches the protective cover 32 from the front end 28 as shown in FIG. 3. Once the adhesive layer 30 is exposed, the wristband 18 is wrapped around an object to be identified such that the exposed adhesive layer 30 on the front end 28 contacts and adhesively retains the rear end 34 of the strap 36 in an encircling relationship around the object to be identified. In this manner, the bottom portion of the front end 28 having the adhesive layer 30 adheres to the top portion of the rear end 34.

The clasp closure mechanism 26 is a separate and independent closure mechanism relative to the adhesive closure mechanism 24, described above. The clasp closure mechanism 26 generally includes a male connector 38 and a female connector 40. Accordingly, the front end 28 is capable of folding upon itself such that the male connector 38 can insert into and lock with the female connector 40. In this regard, engagement of the male connector 38 to the female connector 40 preferably locks together such that a patient or other object to be identified cannot easily unsnap or unlock the clasp closure mechanism 26. Additionally, a person of ordinary skill in the art will readily recognize that the positioning of the male connector 38 relative to the female connector 40 can vary by application. For example, the male connector 38 and the female connector 40 may be flip-flopped relative to the embodiment shown in FIG. 2. Alternatively, the connectors 38, 40 may be aligned vertically rather than horizontally as in FIG. 2. The male connector 38 and the female connector 40 may protrude out from the base of the wristband 18 or, alternatively, may be formed approximately flush with the base of the wristband 18.

One important aspect of the clasp closure mechanism 26 is that the connectors 38, 40 are capable of engaging any one of a plurality of snap-slits 42 located on the strap 36. The snap-slits 42 are preferably evenly spaced along the length of the strap 36 as shown in FIG. 2. The snap-slits 42 are not holes, but rather asterisk shaped piercings through the thickness of the strap 36 of the wristband 18. The connectors 38, 40 are capable of penetrating the width of the strap 36 by being pushed through the snap-slits 42 corresponding to the diameter of the object to be identified. To encircle an object using the clasp closure mechanism 26, a user detaches the wristband 18 from the multi-part form 12, encircles an object to be identified with the wristband 18, then folds the connectors 38, 40 into a desired snap-slit 42 in the strap 36. One or both of the connectors 38, 40 puncture the selected snap-slit 42 for reception into one another. In this regard, the connectors 38, 40 engage one another within an aperture formed by piercing the corresponding snap-slit 42. Notably, insertion of the connectors 38, 40 through the snap-slit 42 does not otherwise disengage a “chad”. Eliminating “chads” eliminates any possibility that such material may fall out and jam a printer during printing. This is important as the laser wristband tags 10, the labels 14 and the wristband 18 are capable of being used in multiple environments. These environments naturally include situations where a printer applies information to the multi-part form 12 in accordance with the embodiments disclosed herein. For example, a printer may be deployed locally such that information is imparted to the wristband 18 at the location of the object to be identified, such as in a hospital. The asterisk shaped piercings that comprise the snap-slits 42 further provides enhanced material consistency along the length of the strap 36 such that any of the aforementioned printers are capable of printing information along the strap 36, if desired. Although, information is preferably not printed directly to the strap 36 because portions of the strap 36 may be cut and removed during application or otherwise covered by any one of a plurality of the laser wristband tags 10, in accordance with the embodiments disclosed herein. Moreover, the laser wristband tags 10 provide a larger printing surface and identification area.

An additional extender 44 may be added to the rear end 34 of the strap 36 to extend the length of the wristband 18. Any suitable method known in the art for retaining the strap 36 to the extender 44 may be used. In accordance with the present disclosure, the extender 44 may interconnect with the strap 36 with a comparable adhesive closure mechanism 24 or clasp closure mechanism 26. In this regard, methods for connecting the extender 44 to the strap 36 may be chemical or mechanical. For example, a portion of the extender 44 or the strap 36 may have an exposable adhesive protected by a cover, similar to that of the protective cover 32 on the front end 28 of the wristband 18. Exposing the adhesive (not shown) enables the extender 44 to be adhesively retained to the strap 36. Likewise, a mechanism similar to the clasp closure mechanism 26 may be formed integral to one end of the extender 44 or the rear end 34 of the wristband 18, to interconnect adjoining snap-slits 42 in the extender 44 and the strap 36. A similar clasp closure mechanism 26 may also be provided separately. FIG. 2 illustrates the extender 44 having a plurality of the snap-slits 42. These snap-slits 42 are functionally and structurally equivalent to the snap-slits 42 in the wristband 18. The snap-slits 42 in the wristband 18 and the extender 44 are die-cut through the width of the band material thereof to allow for attachment via the clasp closure mechanism 26.

In another aspect of retaining the wristband 18 in an encompassing relationship around an object to be identified, an insertion slot 46 is provided therein in the front end 28 of the wristband 18. The insertion slot 46 may be used with either the adhesive closure mechanism 24 or the clasp closure mechanism 26. In general, the insertion slot 46 is a slit extending through the width of the material of the wristband 18. The width of the slit itself is wider than the width of the strap 36 as generally shown in FIGS. 2-3 and 6-7. Thus, the insertion slot 46 functions to slidably retain and align the rear end 34 with the front end 28 of the wristband 18. In this aspect, the rear end 34 is wrapped around an object to be identified and threaded through the insertion slot 46. The portion of the strap 36 extending through the insertion slot 46 is then affixed to the front end 28 by means of the adhesive closure mechanism 24 or the clasp closure mechanism 26, as described above. The insertion slot 46 prevents the strap 36 threaded therethrough from twisting or otherwise moving side-to-side. Hence, the insertion slot 46 improves alignment of the wristband 18 when attached to the identified object. In this regard, the wristband 18 is more comfortable to wear, stays aligned when secured in the closed loop relationship and enhances the readability and scanability of an identification area 48 on the wristband 18 or the identification area 22 on the laser wristband tags 10.

A sample laser wristband tag 10 is shown in FIG. 4 detached from the multi-part form 12 of FIGS. 1 and 2. The laser wristband tag 10 includes a pair of slits 50 formed through the width thereof. The laser wristband tag 10 also includes an adhesive 52 underlying a tab portion 54. The tab 54 includes a cover 56 that provides protection for the adhesive 52. FIG. 5 illustrates a cross-sectional view of the laser wristband tag 10, including the tab 54 and the cover 56 having the adhesive 52 sandwiched therebetween. The cover 56 is preferably at least partially connected to the main body of the laser wristband tag 10 such that it remains substantially attached thereto after removal from the multi-part form 12. In this regard, the adhesive 52 is not automatically exposed before application of the laser wristband tag 10 to the wristband 18. This is particularly ideal because the laser wristband tag 10 may be attached to the strap 36 by the slits 50 or by the adhesive 52, as described in more detail below.

The laser wristband tag 10 is attachable along the length of the strap 36 via the slits 50 (FIG. 6) or via the adhesive 52 (FIG. 7). In one embodiment of the laser wristband tag 10 shown in FIG. 6, the slits 50 allow for threaded engagement along the length of the strap 36 of the wristband 18. Here, the rear end 34 is fed through a first slit 50, for travel underneath the identification area 22, and through the opposite slit 50 for slide fit retention along the length of the strap 36. The laser wristband tag 10 may be threaded as shown in FIG. 6, wherein the tab 54 is pointed up or the laser wristband tag 10 may be threaded oppositely such that the tab 54 points downward. In either embodiment, the identification area 22 remains visible at all times. The identification area 22 may also vary in size and area depending on the desired application. For example, the identification area 22 may be greater in width than the identification area 48 of the wristband 18. Preferably, the identification area 22 is large enough to carry pertinent information regarding the identified object. Any printed information should be readable (e.g. alphanumeric characters or a bar code) or, at least, clearly visible (e.g. a picture). For example, the identification area 22 may include a patient picture, name, address, allergies or other identification or medical information. Accordingly, application of the laser wristband tag 10 to the wristband 18 via the slits 50 must occur before the wristband is secured around an object to be identified.

Alternatively, the laser wristband tag 10 may be attached to the wristband 18 by means of the adhesive 52 disposed underneath the tab 54, in the manner generally shown in FIG. 7. Before application, the removable cover 56 protects the adhesive 52 thereunder. A score line 58 (FIG. 5) formed in the bottom layer of the laser wristband tag 10 allows separation of the removable peel-off protective cover 56 from the rest of the base stock. Removal of the peel-off cover 56 exposes the adhesive 52 underneath the tab 54 for adhesively attaching the laser wristband tag 10 to the wristband 18. The laser wristband tag 10 may be attached to the strap 36 before or after attaching the wristband 18 to an object to be identified. The laser wristband tag 10 is preferably adhered to the strap 36 by folding a portion of the tab 54 about the strap 36 as shown in FIG. 7. One key aspect of the adhesive 52 is that the laser wristband tag 10 may be added to the wristband 18 at any time without physical removal of the wristband 18 from the identified object. In one embodiment, the adhesive 52 may be specially formulated such that it is removable from the surface of the strap 36. But, the adhesive 52 preferably remains substantially or permanently affixed to the strap 36 by the adhesive 52. In this embodiment, the laser wristband tag 10 cannot otherwise be detached therefrom without some form of additional physical force. In this regard, the laser wristband tag 10 should not be easily detachable from the strap 36 during the normal course of identifying an object. In another aspect of this embodiment, multiple laser wristband tags 10 may be adhesively attached to the strap 36. The laser wristband tags 10 may also alternate between being applied to the bottom (FIG. 7) or top portion of the strap 36.

In a particularly preferred embodiment, the wristband 18 and corresponding laser wristband tags 10 are used in a hospital setting. For example, the wristband 18, the laser wristband tags 10, and the labels 14 are printed via the multi-part form 12. After printing, a healthcare provider may simply place the multi-part form 12 in a patient file along with any records for later use. When the healthcare provider is ready to band a patient, the wristband 18 is punched out or otherwise removed from the multi-part form 12. Accordingly, the wristband 18 is applied to the patient by either of the previously described adhesive closure mechanism 24 or the clasp closure mechanism 26. The laser wristband tags 10 may be attached to the wristband 18 via the slits 50 prior to application or post-application by the adhesive 52. Alternatively, multiple laser wristband tags 10 may be applied to the wristband 18 in a combination of the slits 50 and the adhesive 52. In this regard, one or more laser wristband tags 10 may be applied to the strap 36 via the slits 50 prior to application of the wristband 18 around an object to be identified. Thereafter, one or more laser wristband tags 10 may be applied, removed or replaced along the strap 36 by means of the adhesive 52 underneath the tab 54 of the laser wristband tag 10. At any given time, the identified object may have no laser wristband tags 10 attached thereto, multiple laser wristband tags 10 attached via the slits 50, multiple laser wristband tags 10 attached via the adhesive 52, or any combination thereof.

In the hospital setting, adding the adhesive 52 and corresponding tab 54 to the laser wristband tags 10 for post-application of the wristband 18 has a significant advantage in the area of infant identification. A mother and baby can be banded immediately after birth to properly associate the baby with the mother before the two are separated. Additional laser wristband tags 10 with identifying bar codes or other information are thereafter added to the wristband 18 as needed. The identification area 22 of the laser wristband tag 10 is large enough that the curvature of the wristband 18 around even the wrist of a small baby will not interfere with scanability of a bar code thereon or readability of other alphanumerical characters printed thereon. The laser wristband tag 10 is added via the adhesive 52 underneath tab 54 without needing to remove the wristband 18 from the baby or the mother. It is also possible to change-out one or more laser wristband tags 10 without removal of the wristband 18. In the preferred embodiment, more permanent laser wristband tags 10 are added via the pair of slits 50, while less permanent or additional tags are added via the adhesive 52.

While the wristband 18 is preferably used in a hospital setting, a person of ordinary skill in the art will readily appreciate that the multi-part form 12 and the corresponding wristband 18, the laser wristband tags 10, and the labels 14 have multiple applications outside of the hospital setting. For example, the wristband 18 could be used to identify persons at amusement parks, restaurants, bars, clubs, tours, businesses, sporting events, or any other area, building or location where persons are identified. The laser wristband tags 10 and the labels 14 may also be used in any of these applications in conjunction with the wristband 18. In one example, a person receives an identification wristband 18 in an airport and the laser wristband tags 10 or the labels 14 are attached to the wristband wearer's luggage. The wristband 18 associates identification of the passenger with the passenger's luggage. Alternatively, in an amusement park setting, a plurality of the laser wristband tags 10 may be initially applied to the strap 36 of the wristband 18. The laser wristband tags 10 attached thereto may later be removed and redeemed as cash, or for food, games or prizes. Accordingly, the laser wristband tags 10, as used in conjunction with the wristband 18 and the labels 14, have a wide variety of applications of which the present invention should not be limited to the preferred embodiments disclosed herein.

In another aspect of the present invention, the tab 54 is capable of folding back upon the laser wristband tag 10 as generally shown in FIG. 8. In this embodiment, the adhesive 52 does not adhere directly to the strap 36, but rather to a back side 60 of the laser wristband tag 10. Bending the tab 54 about the strap 36 effectively creates a loop 62 through which the strap 36 can pass. The laser wristband tag 10 may then slide along the length of the strap 36. In this regard, the laser wristband tag 10 is designed to be attached to the strap 36 of the wristband 18 after application of the wristband 18 to an object to be identified. Therefore, the loop 62 encircles the wristband 18 already secured around an object. The added laser wristband tags 10 may be color coded to correspond to specific medical alerts, such as allergies, fall risks and DNR orders. Colors may include green, yellow and red, among other coded colors.

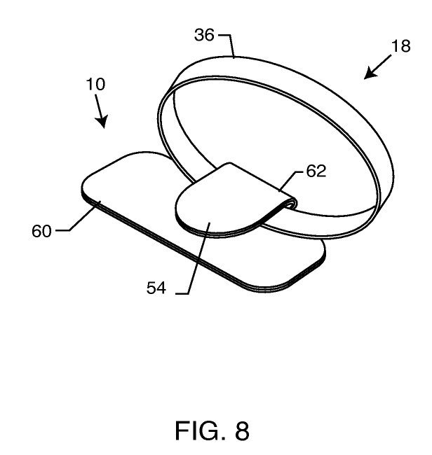

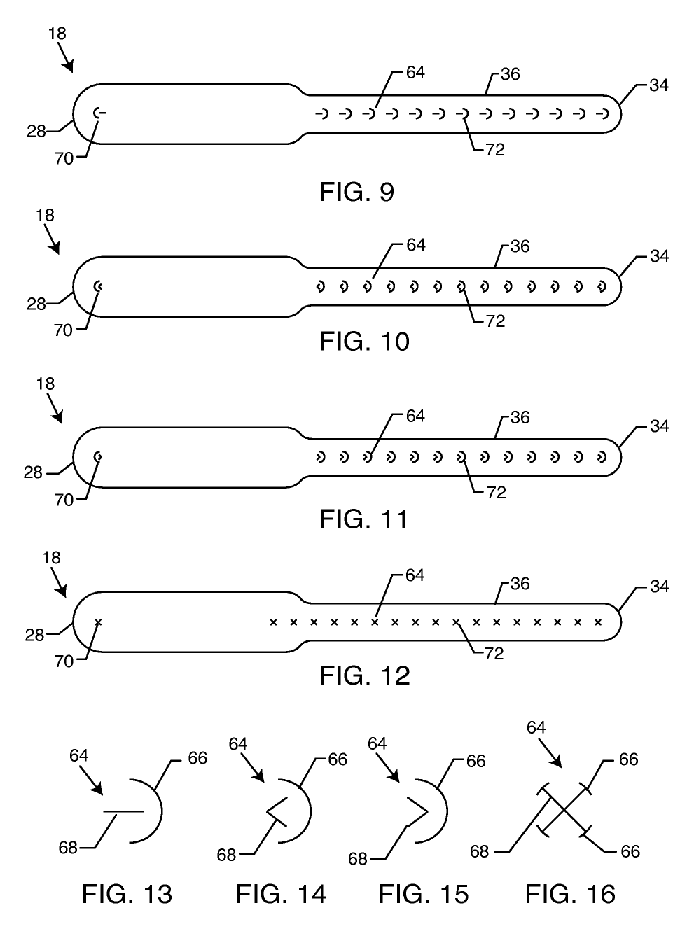

FIGS. 9-16 illustrate alternative embodiments of the present invention, wherein the wristband 18 incorporates a variety of a closure mechanism receiving apertures 64 in place of the snap-slits 42. In this regard, FIGS. 9-12 illustrate the wristband 18 including various embodiments of the closure mechanism receiving aperture 64 and FIGS. 13-16 illustrate enlarged views of the corresponding closure mechanism receiving apertures 64 in FIGS. 9-12.

The closure mechanism receiving apertures 64 are not holes, but rather a series of cuts or piercings through the material of the wristband 18 or the strap 36, similar to the snap-slits 42. Thus, the closure mechanism receiving aperture 64 does not have “chads” that may disconnect from the wristband 18 or the strap 36. The “chads” are essentially waste material that may undesirably accumulate at the point of manufacture. Machines that produce wristbands having these “chads” tend to generate waste material at workstations. Eliminating the “chads” eliminates the need to vacuum such a workstation. Moreover, reducing the quantity of loose material at the point of manufacture effectively reduces the potential for clogging the machine manufacturing the wristbands. In a similar sense, “chads” remaining in the wristband or strap after manufacture may fall out and jam a printer during printing. When used with laser printers, “chads” may be heated and fused to the print drum, thereby ruining the printer.

FIGS. 9-12 illustrate a set of preferred embodiments of the closure mechanism receiving aperture 64. In these preferred embodiments, the closure mechanism receiving aperture 64 includes a scallop or arcuate cut 66 and a post-slit 68. The arcuate cut 66 is oriented such that the convex side points toward the ends of the wristband 18. The configuration of the arcuate cut 66 prevents the wristband 18 from tearing along the arcuate cut 66 of the closure mechanism receiving aperture 64 due to tension stress along the length of the wristband 18. In this aspect, the arcuate cut 66 should be oriented such that the convex side points in the anticipated direction of stress. In most wristbands, such as the wristband 18, this stress is a tension stress along the length of the wristband 18. When the wristband 18 is secured in a closed loop about an object to be identified, a retainment stud (not shown) passes through the post-slits 68 of paired closure mechanism receiving apertures 64 such that any tension on the wristband 18 causes the ends thereof to pull apart. Pulling the wristband 18 along its length thereof causes tensional stress directed along the ends of the wristband 18.

The post-slits 68 are preferably a single cut oriented generally perpendicular to the arcuate cut 66 as best illustrated in FIG. 13. The post-slits 68 are oriented such that the force vector resulting from longitudinal stress on the wristband 18 at the closure mechanism receiving aperture 64 is directed generally transverse to the arcuate cut 66. The post-slits 68 may include a variety of designs that include the V-shaped cut as illustrated in FIGS. 14-15 or an X-shaped cut as illustrated in FIG. 16. The V-shaped post-slits 68 may be oriented with the point of the V directed toward the arcuate cut 66 (FIG. 14) or away from the arcuate cut 66 (FIG. 15). When the post-slit 68 comprises the X-shaped cut, the arcuate cut 66 is preferably segmented into a plurality of arcuate cuts 66, with an arcuate cut 66 placed at the end of each arm of the X-shaped cut (FIG. 16).

The shape of the closure mechanism receiving aperture 64 is unique in its performance because the arcuate cut 66 forms a radius or arc of a circle similar to the portion of a corresponding hole had it been punched out. The post-slit 68 in the form of a single cut (FIG. 13), a V-shaped cut (FIGS. 14-15) or the X-shaped cut (FIG. 16) without the arcuate cut 66 would not form a circle pattern. When a post or other stud is inserted into a non-circular pattern, the pattern has a tendency to continue to tear along the corners, apexes or, in the case of an X-shaped cut, along the arms of the X-shape. The closure mechanism receiving aperture 64 with the arcuate cut 66 terminates any tears and tends toward a circular shape when pulled or stressed. The arcuate cut 66 creates a stronger, more stable closure mechanism receiving aperture 64 when compared to the post-slit 68 without the arcuate cut 66.

As illustrated in FIGS. 9-12, the closure mechanism receiving aperture 64 is positioned along the strap 36 of the wristband 18 such that a securing aperture 70 is positioned at the front end 28 and a plurality of sizing apertures 72 are positioned along the length of the strap 36 toward the rear end 34 of the wristband 18. FIGS. 9-12 illustrate separate wristbands 18 illustrating different types of the closure mechanism receiving aperture 64 integrated therein. But, the types of the closure mechanism receiving aperture 64 used with a particular wristband 18 may be mixed as desired. In this regard, the wristband 18 may include one or more straight cuts (FIG. 13), one or more V-shaped cuts (FIGS. 14-15) or one or more X-shaped cuts (FIG. 16). Regardless of the type of closure mechanism receiving aperture 64 used, the wristband 18 retains the same tear resistant qualities disclosed above.

Moreover, the closure mechanism receiving aperture 64 of the embodiments disclosed herein provide a substantially contiguous, uninterrupted (i.e., no holes or punch-outs) planar surface on the wristband 18 and the strap 36. This contiguous, uninterrupted surface increases the available printable surface area on the wristband 18 and the strap 36. The pattern of the closure mechanism receiving aperture 64 may receive printed information from a thermal or laser printer. These thermal or laser printers are unable to print to a sheet that has a plurality of holes therein due to prior art “chads” being punched-out from within the body of the sheet. In this regard, these holes interrupt the available printing area. Printers are unable to print over holes because the ink passes therethrough. Moreover, the “chads” may fall out during printing or processing to block or otherwise damage the machines through which the sheet passes. Accordingly, the closure mechanism receiving aperture 64 eliminates the aforementioned problems in the prior art by presenting an uninterrupted surface and eliminating the so-called “chads”. The closure mechanism receiving aperture 64 provides a substantially contiguous, uninterrupted planar surface that can receive printed information from a printer without interruption of the corresponding image or information. For example, a bar code may be printed to the area of the closure mechanism receiving aperture 64 for subsequent use with a scanner. Additionally, tooling for punching the closure mechanism receiving aperture 64 is less expensive and easier to construct because the shapes of the closure mechanism receiving aperture 64 are generally circular and do not require removal of waste material during manufacturing.

Although several embodiments have been described in detail for purposes of illustration, various modifications may be made to each without departing from the scope and spirit of the invention. Accordingly, the invention is not to be limited, except as by the appended claims.

What is claimed is:

1. A wristband system, comprising:
a tag having an identification area for receiving information associated with an object to be identified;
a dual attachment mechanism associated with the tag, the dual attachment mechanism comprising a slit in the tag and an adhesive disposed on at least a portion of the tag; and
an elongated flexible strap having a fastener for retaining the strap in a closed loop configuration around the object to be identified, the tag configured to fixedly attach to the strap by threaded engagement of the slit or retention by the adhesive.

2. The wristband system of claim 1, wherein the slit comprises a plurality of slits, each configured for threaded reception of the strap.

3. The wristband system of claim 2, wherein the identification area of the tag remains substantially unobstructed after threaded engagement of the tag to the strap.

4. The wristband system of claim 1, wherein the adhesive is disposed between a selectively removable protective cover and a tab integral to the tag.

5. The wristband system of claim 1, wherein the tag comprises an RFID circuit.

6. The wristband system of claim 1, wherein the tag, the strap and an associated label comprise at least a portion of a printable multi-part form.

7. The wristband system of claim 6, wherein score lines detachably define the tag, the label or the strap in the multi-part form.

8. The wristband system of claim 6, wherein the label and the strap include an identification area for receiving information associated with the object to be identified.

9. The wristband system of claim 1, wherein the tag includes human readable alphanumeric characters and/or machine readable information in the identification area.

10. The wristband system of claim 9, wherein the machine readable information comprises a bar code.

11. The wristband system of claim 1, wherein a plurality of the tags are affixed to the strap.

12. The wristband system of claim 1, wherein the fastener comprises an adhesive retention mechanism or a mechanical retention mechanism.

13. The wristband system of claim 12, wherein the adhesive retention mechanism comprises an adhesive disposed on at least a portion of the strap.

14. The wristband system of claim 12, wherein the mechanical retention mechanism comprises a complementary pair of connectors.

15. The wristband system of claim 14, wherein the strap includes a snap-slit configured for selective reception of the connectors.

16. The wristband system of claim 1, wherein the strap includes an alignment slot.

17. The wristband system of claim 1, including an elongated flexible extender for lengthening the strap.

18. The wristband system of claim 1, wherein the adhesive attaches to the tag for looped attachment around the strap after the strap is securely attached to the object to be identified.

19. The wristband system of claim 1, wherein the strap includes one or more closure mechanism receiving apertures presenting a substantially contiguous planar surface and comprises an arcuate cut and a post-slit approximate thereto.

20. The wristband system of claim 19, wherein the post-slit is oriented generally longitudinally along the strap and generally perpendicular to the arcuate cut.

21. The wristband system of claim 19, wherein the post-slit comprises a V-shaped cut generally centered on a radius of the arcuate cut.

22. The wristband system of claim 19, wherein the post-slit comprises an X-shaped cut generally centered on a radius of the arcuate cut.

23. The wristband system of claim 22, wherein the arcuate cut is positioned at an end of each X-shaped cut.

24. A wristband system, comprising:
a tag having an identification area for receiving information associated with an object to be identified;
a dual attachment mechanism associated with the tag, the dual attachment mechanism comprising a plurality of slits in the tag and an adhesive disposed on at least a portion of the tag; and
an elongated flexible strap having a fastener comprising an adhesive retention mechanism or a mechanical retention mechanism for retaining the strap in a closed loop configuration around the object to be identified, the tag configured to fixedly attach to the strap by threaded engagement of the slits or retention by the adhesive, wherein the identification area of the tag remains substantially unobstructed after engagement of the tag to the strap.

25. The wristband system of claim 24, wherein the adhesive is disposed between a selectively removable protective cover and a tab integral to the tag, the tag further comprising an RFID circuit.

26. The wristband system of claim 24, wherein the tag, the strap, an associated label and an elongated flexible extender for lengthening the strap comprise at least a portion of a printable multi-part form, the tag including human readable alphanumeric characters and/or machine readable information comprising a bar code.

27. The wristband system of claim 26, wherein the label and the strap include an identification area for receiving information associated with the object to be identified.

28. The wristband system of claim 24, wherein the adhesive retention mechanism comprises an adhesive disposed on at least a portion of the strap, the mechanical retention mechanism comprises a complementary pair of connectors and the strap includes an alignment slot.

29. The wristband system of claim 24, wherein the adhesive attaches to the tag for looped attachment around the strap after the strap is securely attached to the object to be identified.

30. The wristband system of claim 24, wherein the strap includes one or more snap-slits or closure mechanism receiving apertures presenting a substantially contiguous planar surface.

31. The wristband system of claim 30, wherein the closure mechanism receiving apertures comprise an arcuate cut and a post-slit generally perpendicular to the arcuate cut, the post-slit comprising a V-shaped cut or an X-shaped cut generally centered on a radius of the arcuate cut.
